(19) United States
(12) Patent Application Publication
(10) Pub. No.: US 2019/0179308 A1
(43) Pub. Date: Jun. 13, 2019

(54) VEHICLE APPARATUS AND VEHICLE SYSTEM

(71) Applicant: DENSO CORPORATION, Kariya-city, Aichi-pref. (JP)

(72) Inventor: Yosuke HATTORI, Kariya-city, Aichi-pref. (JP)

(21) Appl. No.: 16/308,131

(22) PCT Filed: Jun. 5, 2017
(86) PCT No.: PCT/JP2017/020806

§ 371 Date: Dec. 7, 2018

(30) Foreign Application Priority Data
Jun. 7, 2016 (JP) 2016-113868

(51) Int. Cl. G05D 1/00; B60W 40/09

(52) U.S. Cl. CPC G05D 1/0061; G05D 1/0088; B60W 2540/30; G05D 2201/0213; B60W 40/09

(57) ABSTRACT

A vehicle apparatus is applied to a vehicle and enables automatic driving to a destination without requiring a driving operation by a user. The apparatus includes an information obtaining section that obtains information indicating that the automatic driving is used by the user as charged automatic driving, and a usage parameter calculation section which calculates a usage parameter which is at least one of a usage time period and a usage distance of the charged automatic driving by the user, based on the information obtained by the information obtaining section.

### CROSS-REFERENCE TO RELATED APPLICATION

This application is based on Japanese Patent Application No. 2016-113868 filed on Jun. 7, 2016, the description of which is incorporated herein by reference.

### TECHNICAL FIELD

The present disclosure relates to a vehicle apparatus and a vehicle system which are applied to a vehicle that can perform automatic driving.

### BACKGROUND ART

As disclosed in PTL 1, for example, vehicles are known which can perform automatic driving to a destination without requiring driving operation by the user.

### CITATION LIST

### Patent Literature

PTL 1: JP 2015-141053 A

### SUMMARY OF THE INVENTION

As the degree of a user's intervention in the driving operation becomes smaller, the automatic driving performance of the vehicle needs to be higher. This means development and design costs are increased. This may involve cost increase when users introduce vehicles to which the automatic driving system is mounted.

Since the need for automatic driving depends on the users, the degree of dependency on vehicles having an automatic driving function may greatly depend on the users. For users with small dependency on the vehicle, the high cost of introducing such a vehicle is not justified by the use of the automatic driving. In this case, there are concerns that users with little dependency on the vehicle may bear a great financial burden. Therefore, there still remains a technical problem to be solved before accomplishing a business model using a vehicle that enables automatic driving to a destination without requiring the user's driving operation.

The present disclosure aims to provide a vehicle apparatus and a vehicle system which contribute to accomplishing a business model using a vehicle that performs automatic driving.

Hereinafter, description will be given of the solution to the problem set forth above and the advantageous effects thereof.

The present disclosure relates to a vehicle apparatus which is applied to a vehicle and enables automatic driving to a destination without requiring a driving operation by a user. The apparatus includes an information obtaining section which obtains information indicating that the automatic driving is used by the user as charged automatic driving, and a usage parameter calculation section which calculates a usage parameter which is at least one of a usage time period and a usage distance of the charged automatic driving by the user, based on the information obtained by the information obtaining section.

An inventor of the present application has studied a practically preferable business model to reduce the cost incurred in the user's introduction of the vehicle which performs automatic driving. The inventor of the present application has conceived an idea that instead of reducing the cost required for the user to introduce the vehicle, a business model for charging the user is appropriate, by which the user is charged according to at least one of usage time period and a usage distance of the charged automatic driving by the user.

In the above disclosure, a usage parameter which is at least one of usage time period and usage distance of the user-charged automatic driving is calculated, based on the information that the automatic driving is being used by the user as charged automatic driving. Therefore, according to above disclosure, the usage parameter is grasped which is necessary to calculate the usage charge that should be collected from the user. This can contribute to the accomplishment of the business model in which users are charged according to the usage parameter.

In addition to the above disclosure, the following disclosure can contribute to accomplishment of the business model. A vehicle system is provided with a vehicle apparatus which is applied to a vehicle and enables automatic driving to a destination without requiring a driving operation by a user, and a management server. The vehicle apparatus transmits information indicating that the automatic driving is used by the user as charged automatic driving, to the management server. The management server includes a usage parameter calculation section that receives the information indicating that the charged automatic driving is used, and based on the received information, the usage parameter calculation section calculating a usage parameter which is at least one of a usage time period and a usage distance of the charged automatic driving.

### BRIEF DESCRIPTION OF DRAWINGS

Referring to the accompanying drawings, specific description will be provided below to clarify the above objective and other objectives, characteristics and advantageous effects of the present disclosure. In the drawings:

FIG. 1 is an overall configuration view of a charging system for a vehicle according to a first embodiment;

FIG. 2 is a flowchart illustrating a procedure of a process of calculating a usage time period for charged automatic driving executed on the vehicle side;

FIG. 3 is a flowchart illustrating a procedure of a charge-exclusion process performed on the vehicle side;

FIG. 4 is a flowchart illustrating a procedure of a non-waking time process performed on the vehicle side;

FIG. 5 is a flowchart illustrating a procedure of a usage charge calculation process for charged automatic driving performed on the server side;

FIG. 6 is a diagram illustrating a relationship between the usage charge per time of the charged automatic driving, and the usage time zone or the like of the charged automatic driving;

FIG. 7 is a flowchart illustrating a procedure of a usage charge notifying process performed on the vehicle side;

FIG. 8 is a flowchart illustrating a procedure of a process of transmitting update charge information performed on the server side;

FIG. 9 is a flowchart illustrating a procedure of a process of notifying the update charge information performed on the vehicle side;

FIG. 10 is a flowchart illustrating a procedure of a process of calculating a usage time period and a charge, which is performed on the vehicle side, according to a second embodiment;

FIG. 11 is a flowchart illustrating a procedure of a usage charge calculation process and a usage charge notification process performed on the vehicle side;

FIG. 12 is a flowchart illustrating a procedure of a notification process of charged automatic driving performed on the vehicle side according to a third embodiment;

FIG. 13 is a flowchart illustrating a procedure of a charge-exclusion process performed on the vehicle side;

FIG. 14 is a flowchart illustrating a procedure of a process of usage time period calculation and charge calculation performed on the server side.

### DESCRIPTION OF THE EMBODIMENT

### First Embodiment

With reference to the drawings, a first embodiment embodying a system for a vehicle according to the present disclosure will be described below. The system automatically makes the vehicle travel to a destination if the destination is inputted, without driving operation by a user. The system is provided with a vehicle apparatus and a management server.

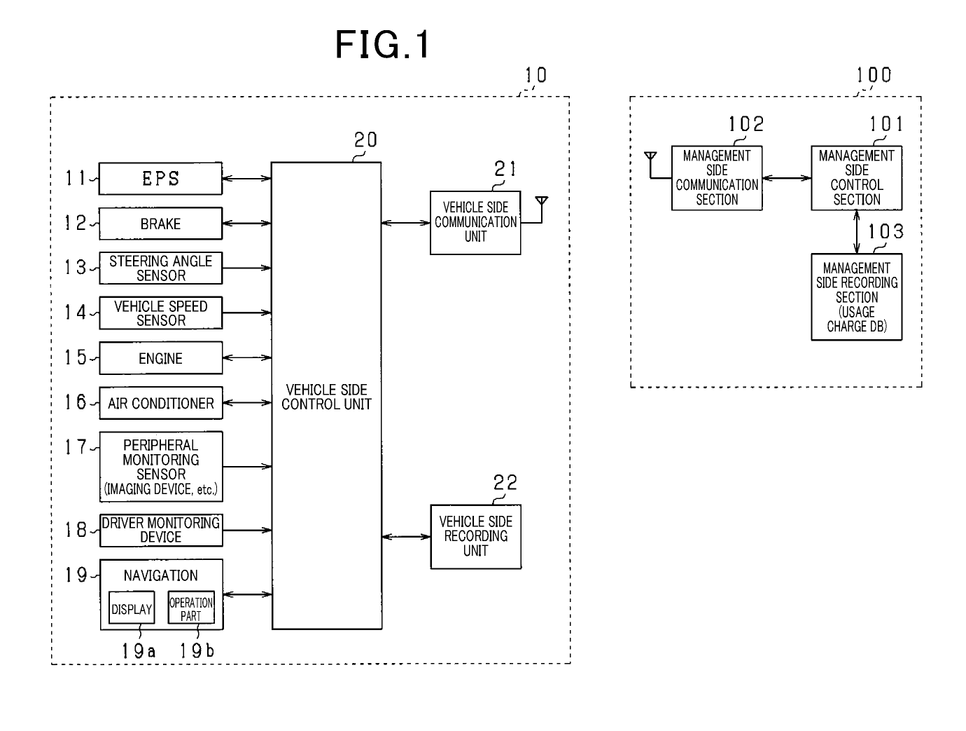

Referring to FIG. 1, a vehicle 10 to which the vehicle apparatus is mounted will be described.

The vehicle 10 includes an electric power steering unit 11, a brake unit 12, a steering angle sensor 13 which detects a steering angle of a steered wheel of the vehicle, and a vehicle speed sensor 14 which detects a traveling speed of the own vehicle.

The electric power steering unit 11 includes a steering motor which applies steering force to the steering wheel, and a steering ECU. When the user operates the steering wheel, the steering ECU executes power steering control which generates assist force at the time when the steering motor changes the steering angle of the steered wheel, based on the steering angle detected by the steering angle sensor 13. The steering ECU executes automatic steering control in which the steering motor automatically controls the steering angle without the steering control by the user.

The brake unit 12 includes a brake actuator for adjusting the hydraulic pressure of the master cylinder, and a brake ECU. The brake ECU performs ABS control, traction control, and the like, which are performed by the brake actuator, based on the hydraulic pressure of the master cylinder, the own vehicle speed, that is, the traveling speed of the own vehicle detected by the vehicle speed sensor 14, and the like. The brake ECU performs automatic brake control in which braking force is automatically imparted to the wheels by the brake actuator without a user's braking operation.

The vehicle 10 includes an engine 15 which serves as a traveling power source, an air conditioner 16 which air-conditions the interior of the vehicle, and a peripheral monitoring sensor 17. The peripheral monitoring sensor 17 has a function to monitor obstacles around the vehicle 10. In the present embodiment, the peripheral monitoring sensor 17 includes an imaging device. The imaging device is an in-vehicle camera including a CCD camera, a CMOS image sensor, a near infrared camera, or the like. The imaging device captures an image around the vehicle, including the road on which the vehicle is traveling. The imaging device is mounted, for example, in the vicinity of the upper edge of the front windshield of the own vehicle, and captures an image of a region extending ahead of the vehicle 10 over a predetermined imaging angle centering on an imaging axis. The imaging device may be a monocular camera or a stereo camera.

The peripheral monitoring sensor 17 may further include at least one of a sonar which detects objects by using ultrasonic waves as transmission waves, a millimeter wave sensor, and a laser sensor.

The vehicle 10 is provided with a driver monitoring unit 18 which monitors an abnormal behavior of the user who sits on the driver's seat. The abnormality of the user includes a dozing state of the user, a direction of the user's line of sight other than the front direction, and great change of the user's posture, and the like. For example, the driver monitoring unit 18 may be a camera which is provided to the instrument panel and captures the user as an imaging object who sits in the driver's seat.

The vehicle 10 is provided with a navigation unit 19. The navigation device 19 includes a display 19a, and an operation part 19b which is operated by the user. In the present embodiment, the display 19a is a touch panel display, and the operation part 19b is an icon type one displayed on the display section 19a. The navigation unit 19 obtains map data from a map storage medium which records road map data and various pieces of information, and calculates a current position of the vehicle 10, based on GPS signals received via a GPS antenna. The navigation unit 19 performs controls such as displaying the current location of the own vehicle on the display 19a, and guiding the route from the current location to the destination.

The vehicle 10 includes a vehicle control unit 20 serving as a vehicle apparatus, a vehicle side communication unit 21, and a vehicle side recording unit 22. The vehicle side communication unit 21 has a function of transmitting information generated by the vehicle side control unit 20 to a management server 100 via the communication network, and a function of receiving information transmitted from the management server 100 via the communication network. The vehicle side recording unit 22 is configured by, for example, a memory.

Next, the managing server 100 will be described.

The management server 100 is provided with a management side control section 101, a management side communication section 102, and a management side recording section 103. The management side communication section 102 has a function of transmitting information generated by the management side control section 101 to the vehicle 10 via a communications network, and receiving information that is transmitted from the vehicle 10 via communication network. The management side recording section 103 is configured by, for example, a memory.

In the vehicle 10 according to the present embodiment, because of the automatic steering control, the automatic braking control, and the combustion control of the engine 15, automatic driving is enabled from the current location to the destination without the user's steering operation, braking operation, and accelerator operation. The destination is set by the user operating the operation part 19b of the navigation unit 19.

When automatic driving is performed, the user can select a charging mode or a non-charging mode. The charging mode is a driving mode in which the responsibility for problems such as an accident which may occur while automatic driving is performed is on the vehicle 10 side rather than the user side. The non-charging mode is a driving mode in which the responsibility for problems such as an accident which may occur while automatic driving is performed is on the user side rather than the vehicle 10 side. In the present embodiment, the operation part 19b of the navigation unit 19 includes an icon type operation part by which the charging mode or the non-charging mode can be selected. The user touches the operation part to select the charge mode or the non-charging mode.

If the charging mode is selected, the user is charged with the usage charge according to the usage time period of automatic driving as the usage parameter. In the present embodiment, automatic driving performed when the charging mode is selected is hereinafter referred to as charged automatic driving, and automatic driving performed when the non-charging mode is selected is referred to as non-charged automatic driving. In the following, description will be given of a process executed by the vehicle side control unit 20 and the management side control unit 101 for calculation of the usage charge.

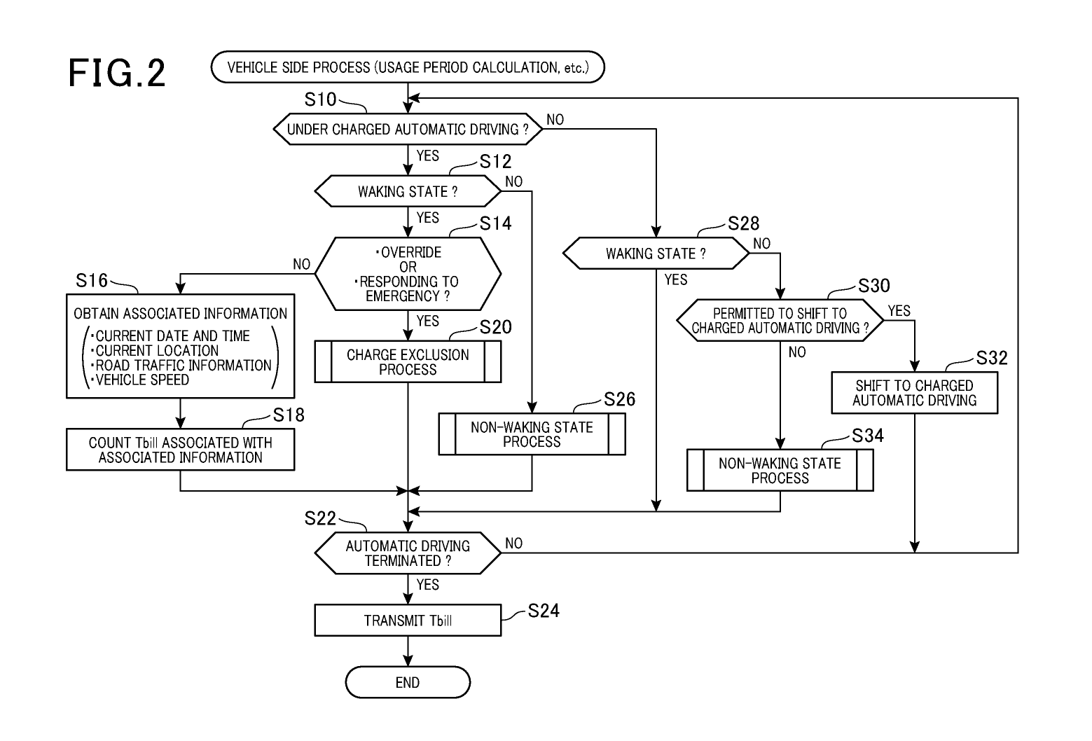

First, referring to FIG. 2, description will be given of the calculation process of the usage time period of the charged automatic driving, which is used for the usage charge calculation. This process is executed, for example, being triggered by the vehicle side control unit 20 being determined as having started automatic driving. After the user has set a destination using the navigation unit 19, the vehicle side control unit 20 determines the start of automatic driving by determining the user's touch operation as having done through the operation part 19b.

In a series of processing, first, in step S10, whether charged automatic driving is being performed is determined. If it is determined that the user has selected the charged mode, the control unit determines that the charged automatic driving is being performed.

If it is determined that the charged automatic driving is being performed in step S10, the control proceeds to step S12 to determine whether the user on the driver's seat is in a waking state. In the present embodiment, whether the driver is in a waking state is determined based on the image captured by the driver monitoring unit 18. In the present embodiment, the process of step S12 corresponds to an abnormality determination part.

If it is determined that the user is in a waking state in step S12, the control proceeds to step S14 to determine whether the logical sum of the conditions is true, the conditions being that there is a user's override operation, and there is a user's emergency action. The override operation refers to a driving operation performed by the user during full-automatic driving. This driving operation includes at least one of the operations of the steering, the accelerator and the brake. Emergency response refers to, for example, taking persons who have been injured or who have suddenly become ill to a hospital by the vehicle 10. Information that emergency response is being performed is inputted to the vehicle side control unit 20 by the user touch-operating the operation part 19b of the navigation device 19 or touching a dedicated button provided to the interior of the vehicle.

If it is determined that there is neither override operation nor emergency response in step S12, the control proceeds to step S16. In step S16, associated information is obtained. In the present embodiment, the associated information includes current date and time information, current location information of the vehicle 10, road traffic information, and vehicle speed information detected by the vehicle speed sensor 14. The road traffic information includes traffic congestion information around the current location. In the present embodiment, the vehicle speed information, the current location information, and the road traffic information correspond to vehicle traveling information, and the current date and time information corresponds to usage time period information.

In the following step S18, the control unit counts up a usage time period Tbill of the charged automatic driving. The counted usage time period Tbill is a time period from the start of the charged automatic driving until the current processing timing of the vehicle side control unit 20. In the present embodiment, step S18 corresponds to a usage parameter calculation part.

In the present embodiment, during the time period from the start of the charged automatic driving until the current processing timing, the usage time period Tbill which corresponds to each processing timing is associated with associated information obtained in step S16. Specifically, the usage time period Tbill corresponding to each processing timing is associated with daytime-or-nighttime information, based on the current date and time information. The usage time period Tbill which corresponds to each processing timing is associated with information indicating an urban area or a suburban area, based on the current location information. The usage time period Tbill which corresponds to each processing timing is associated with information on presence or absence of traffic congestion, based on the road traffic information. Furthermore, the usage time period Tbill which corresponds to each processing timing is associated with the vehicle speed.

If step S18 is completed, the control proceeds to step S22. In step S22, it is determined whether the automatic driving has been terminated. In the present embodiment, if it is determined that the vehicle 10 has arrived at the destination, it is determined that the automatic driving has been terminated. If it is determined that the automatic driving has been terminated, the vehicle 10 is deemed to be stationary.

If a plurality of destinations are set for the navigation unit 19, for example, the termination of the automatic driving may be determined each time the vehicle is determined to have arrived at the destination, or may be determined when the vehicle is determined to have arrived at the final destination. The termination of the automatic driving may be determined if it is determined that the user has turned off the ignition switch of the vehicle 10.

If it is determined in step S22 that the automatic driving has not been terminated, the control proceeds to step S10. In contrast, if it is determined in step S22 that the automatic driving has been terminated, the control proceeds to step S24 to output the usage time period Tbill of the charged automatic driving, which is counted up in step S18, to the vehicle side communication unit 21. In this case, the aforementioned associated information is associated with the information on usage time period Tbill and is outputted to the vehicle side communication unit 21. As a result, information regarding the usage time period Tbill and the associated information are transmitted from the vehicle side communication unit 21. The transmitted information is inputted to the management side control section 101 via the management side communication section 102. After the process of step S24 is terminated, the counted-up usage time period Tbill is reset to zero.

In contrast, if an affirmative determination is made in step S14, the control proceeds to step S20 to perform a charge-exclusion process. This process excludes the time period of the override operation or the emergency response from the usage time period Tbill of the charged automatic driving, even if the charged automatic operation is being performed.

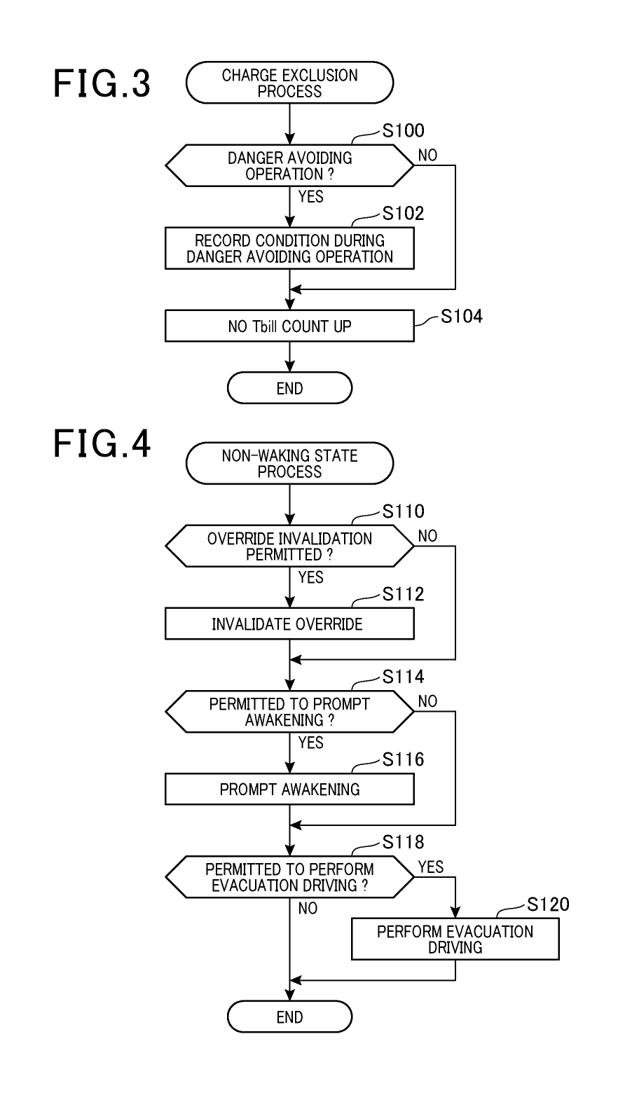

FIG. 3 illustrates the procedure of the charge-exclusion process.

First, in step S100, it is determined whether the user is performing a danger avoidance operation of the vehicle 10. The danger avoidance operation includes a driving operation performed by the user to avoid the vehicle 10 colliding with an object ahead thereof. In the present embodiment, if it is determined that the deceleration of the vehicle 10 is not less than a predetermined deceleration, or if it is determined that variation of the steering angle of the steered wheel per unit time is not less than a predetermined variation, it is determined that the danger avoidance operation is being performed. The deceleration of the vehicle 10 may be calculated based on the detection value of the vehicle speed sensor 14. The variation of steering angle may be calculated, based on the detection value of the steering angle sensor 13. In the present embodiment, the process of step S100 corresponds to a danger determination part.

If an affirmative determination is made in S100, the control proceeds to step S102 to record the conditions at the time of the danger avoidance operation on the vehicle side recording unit 22. Specifically, the information recorded to the vehicle side recoding unit 22 includes: images captured by the imaging device which constitutes the peripheral monitoring sensor 17, a vehicle speed detected by the vehicle speed sensor 14, and a steering angle detected by the steering angle sensor 13. In the present embodiment, step S102 corresponds to a record processing part.

Information recorded in the vehicle side recording unit 22 is used, for example, to clarify where the responsibility for an accident lies. The user can transmit information recorded in the vehicle side recording part 22 to a vehicle manufacturer. The manufacturer can use the information and accomplish a business model, by which reliability of the automatic driving system is improved, and in return the user can receive a rebate from the manufacturer.

After the process of step S102 is terminated, or if a negative determination is made in step S100, the control proceeds to step S104 to not perform counting up the usage time period Tbill of the charged automatic driving. After the process of step S104 is terminated, the series of processing is temporarily terminated.

By preforming the charge-exclusion process, the time period of making an affirmative determination in step S14 of FIG. 2 is excluded from the usage time period Tbill of the charged automatic driving. When step S20 is completed, the control proceeds to step S22.

In the present embodiment, the vehicle side control unit 20 performs the following process, in addition to the calculation process of the usage time period Tbill of the charged automatic driving.

Specifically, if it is determined that the user is not in a waking state in step S12, the control proceeds to step S26 to perform a non-waking time process.

FIG. 4 shows the non-waking time process.

In step S110, it is determined whether the user has permitted invalidation of the override operation. The permission of the invalidation may be selected in advance by, for example, the user touch-operating the operation part 19b of the navigation device 19 or the dedicated button provided to the interior of the vehicle.

If it is determined in step S110 that invalidation of the override operation has been permitted, the control proceeds to step S112 to perform invalidation processing which invalidates the override operation. Thus, if the user dozes off while operating the vehicle 10, and if the steering, the accelerator, or the brake is operated, the driving operation will no longer be reflected in the control of the vehicle 10. In the present embodiment, the process of step S112 corresponds to an invalidation control part.

The invalidation of the override operation may be cancelled if it is determined that the user is in a waking state.

If the process of step S112 is completed, or if a negative determination is made in step S110, the control proceeds to step S114. In step S114, it is determined whether there is permission to facilitate user's awakening. Prompting awakening of the user may be permitted in advance, for example, by the user touching the operation part 19b of the navigation device 19 or the dedicated button provided to the interior of the vehicle.

If an affirmative determination is made in step S114, the control is proceeds to step S116 to perform processing for facilitating user's awakening. In the present embodiment, at least one of an alarm sound of the navigation unit 19, and air blowing from the air conditioner 16 leads the user to a waking state. If a light-emitting device which emits light to the user is provided to the vehicle interior, the light emitted from the light-emitting device may facilitate user's awakening.

If the process of step S116 is completed, or if a negative determination is made in step S114, the control proceeds to step S118. In step S118, it is determined whether there is permission to perform evacuation driving for the vehicle 10. The permission for the evacuation driving may be selected in advance, for example, by the user touching the operation part 19b of the navigation unit 19 or the dedicated button provided to the interior of the vehicle.

If an affirmative determination is made in step S118, the control proceeds to step S120 to perform evacuation driving for the vehicle 10 to the predetermined retreat point. As for the evacuation point, for example, the nearest evacuation point from the current location of the vehicle 10 may be selected among evacuation points registered in advance. In this case, the destination set to the navigation unit 19 may be changed to the evacuation point.

If the process of step S120 is completed, or if a negative determination is made in step S118, a series of processing is temporarily terminated.

Referring back to FIG. 2, when the process of step S26 is completed, the control proceeds to step S22.

If it is determined in step S10 that the charged automatic driving is not being executed, it is determined that the non-charged automatic driving is being executed. The control then proceeds to step S28. In step S28, it is determined whether the user is in a waking state. If it is determined that the user is in a waking state in step S28, the control proceeds to step S22. In contrast, if it is determined in step S28 that the user is not in a waking state, the control proceeds to step S30 to determine whether there is permission for transition to the charged automatic driving. The transition to the charged automatic driving may be permitted in advance, for example, by the user touching the operation unit 19b of the navigation unit 19 or the dedicated button provided to the interior of the vehicle.

If it is determined in step S30 that there is permission for transition, the control proceeds to step S32 to forcibly switch from the non-charged mode to the charged mode. Thus, the driving mode is shifted from the non-charged automatic driving to the charged automatic driving. The control then proceeds to step S10. In the present embodiment, the process of step S32 corresponds to an operation shifting part.

If the permission for transition is set by the user, and if forcible transition to the charged automatic driving is performed, a unit-time charge for the automatic driving may be set higher than that for the ordinary charged automatic driving which is operated from the start of the automatic driving of the vehicle 10.

If the forcible transition to the charged automatic driving is performed, and if it is determined that the user is in a waking state, the driving mode is forcibly switched to the non-charged mode if a predetermined time period has elapsed from the waking determination.

If it is determined in step S30 that there is no permission for transition to perform the charged automatic driving, the control proceeds to step S34 to perform the non-waking time process as illustrated in FIG. 4. If the process of step S34 is completed, the control proceeds to step S22.

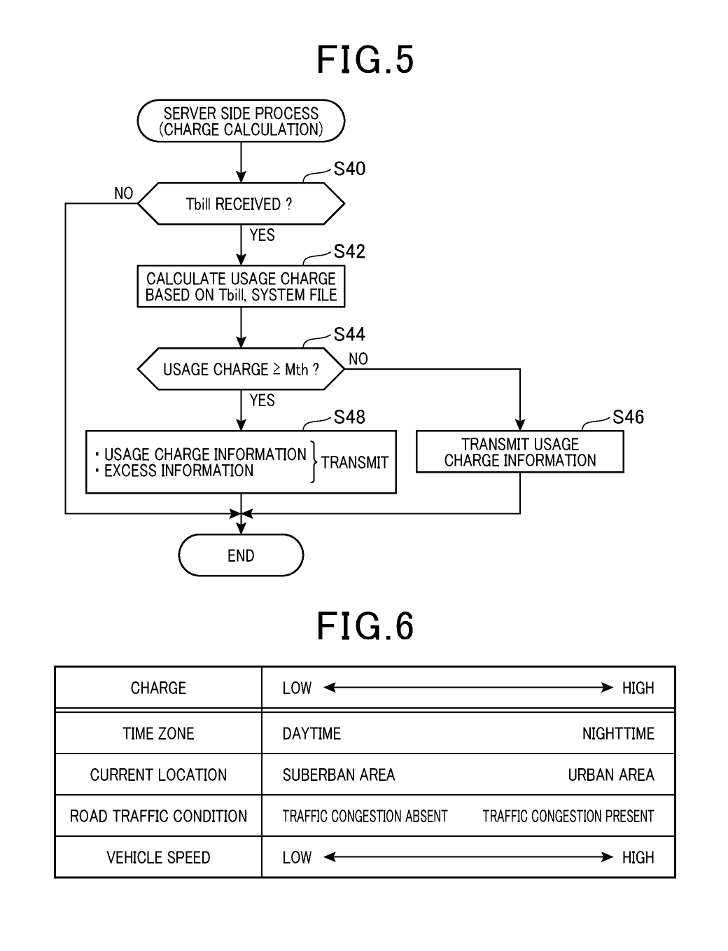

Referring to FIG. 5, a calculation process of the charged automatic driving usage charge based on the usage time period Tbill will be described. This process is repeatedly performed by the management side control section 101 at predetermined processing intervals.

In a series of processing steps, first in step S40, the management side control section 101 determines whether information on the usage time period Tbill and the associated information transmitted from the vehicle side communication unit 21 have been received by the management side communication section 102.

If an affirmative determination is made in step S40, the control proceeds to step S42 to calculate the usage charge of the charged automatic driving, based on the received information on the usage time period Tbill, and the information on the unit-time charge for the charged automatic driving. In the present embodiment, step S42 corresponds to a charge information generation part. The unit-time charge is determined according to profile information of the full-automatic driving system mounted to the vehicle 10. For example, as the performance of the system profile is higher, the unit-time charge is determined to be lower. The profile information includes vehicle manufacturer information, model year information on the automatic driving system, and information on sensors which constitute the system. The profile information is recorded in the management side recording section 103.

As shown in FIG. 6, the unit-time charge of the charged automatic driving is determined according to the associated information associated with the received usage time period Tbill.

For example, when the time zone of using the charged automatic driving is nighttime, the unit-time charge is determined to be higher than that when the usage time period is daytime. When the charged automatic driving is performed in an urban area, the unit-time charge is determined to be higher than that when the charged automatic driving performed in a suburban area. When the vehicle 10 is caught in traffic congestion, the unit-time charge is determined to be higher than that when the vehicle 10 is not caught in traffic congestion. That is, as an example of a time zone of using the charged automatic driving, a system which can perform automatic driving even at nighttime is more complicated than a system which can perform automatic driving only in the daytime. Therefore, cost involved in designing and developing the nighttime system may increase. Thus, when automatic driving is used at nighttime, the unit-time charge is determined to be higher than that when automatic driving is used in the daytime.

As the vehicle speed is higher, the unit-time charge is determined to be higher. In other words, as the speed of the own vehicle is higher, time to collision (TTC) becomes shorter, which is obtained by dividing an inter-vehicle distance between the own vehicle and the preceding vehicle by a relative speed therebetween. In this case, a system configuration is complicated which is required for avoiding a collision between the own vehicle and the preceding vehicle through collision avoidance control. Thus, cost involved in designing and developing the system may increase. Accordingly, as the vehicle speed is higher, the unit-time charge is determined to be higher.

As the vehicle speed is higher, the vehicle arrives at a destination earlier. From this viewpoint of convenience, the unit-time charge of the charged automatic driving may be determined to be higher, as the vehicle speed is higher.

The unit-time charge information correlated to the associated information is recorded in the management side recording section 103 as map data.

Referring back to FIG. 5, in subsequent step S44, the management side control section 101 determines whether the usage charge calculated in step S42 is not less than the upper limit value Mth.

The upper limit value Mth is determined by the user operating the operation part 19b of the navigation unit 19. This process is performed to notify the user that the usage charge has become not less than the upper limit value Mth.

If a negative determination is made in step S44, the control proceeds to step S46 to output the usage charge information to the management side communication section 102. The usage charge information includes the usage charge calculated in step S42 and the usage time period Tbill received in step S40. Thus, the management side communication section 102 transmits the usage charge information to the vehicle side communication unit 21.

In contrast, if an affirmative determination is made in step S44, the control proceeds to S48 to output excess information that the usage charge exceeds the upper limit value Mth, in addition to the usage charge information, to the management side communication section 102.

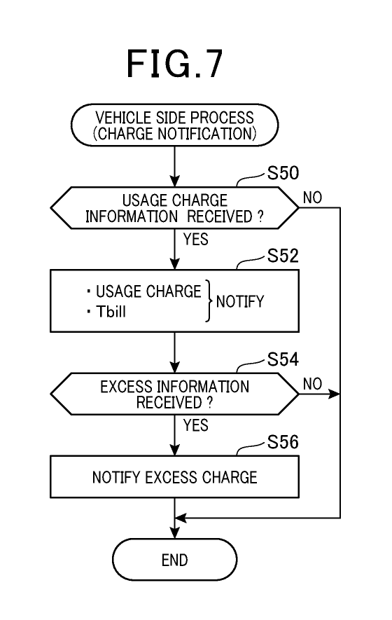

Next, referring to FIG. 7, description will be given of a process of notifying the user of the vehicle 10 of the usage charge information transmitted from the management server 100. The vehicle side control unit 20, for example, repeatedly executes this process at predetermined processing intervals.

In step S50 of the series of processing steps, the vehicle side control unit 20 determines whether the usage charge information generated by the management side control section 101 has been received by the vehicle side communication unit 21.

If an affirmative determination is made in step S50, the control proceeds to step S52 to notify the user of the usage time period Tbill of the automatic driving, and the usage charge corresponding to the usage time period Tbill, through the navigation unit 19. This notification may be performed by at least one of the display part 19a of the navigation unit 19 and a voice from the navigation unit 19. The notified usage time period Tbill may be a time period from the determination of the start of the automatic driving until the determination of the termination of the automatic driving in step S22 of the FIG. 2, or may be a cumulative usage time period until the current processing interval.

Subsequently, in step S54, the vehicle side control unit 20 determines whether the vehicle side communication unit 21 has received the excess information. If an affirmative determination is made in step S54, the control proceeds to step S56 to notify the user of information that the usage charge exceeds the upper limit value, through the navigation unit 19.

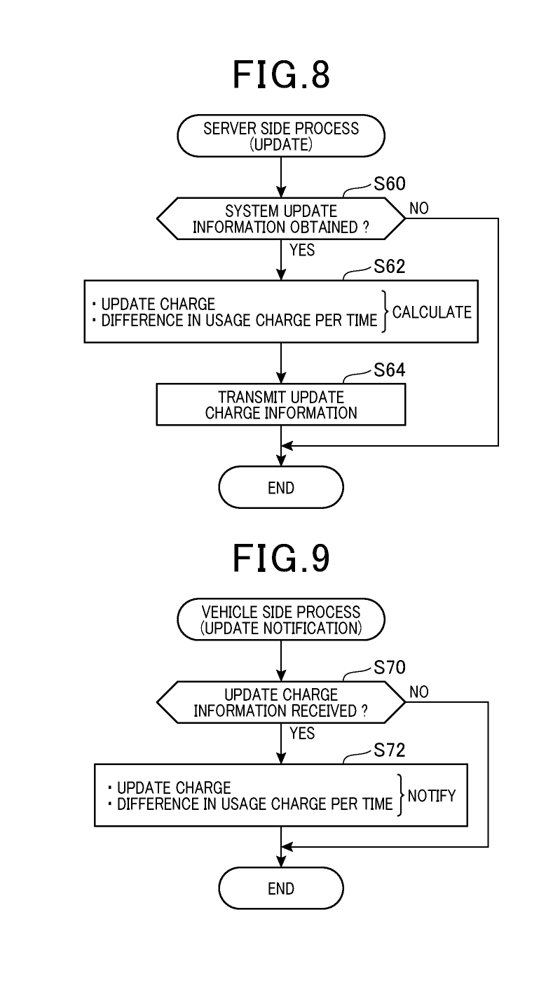

In the present embodiment, if the automatic driving system can be updated to an automatic driving system which has a different profile, update charge information is notified to the user. This update charge information includes information on charge incurred in updating the system, and information on the difference in unit-time charge for the charged automatic driving before and after the update of the system. Referring to FIGS. 8 and 9, a process for the update charge information will be described.

FIG. 8 illustrates a procedure of a process performed by the management side control section 101. This process is, for example, repeatedly executed at predetermined processing intervals.

In a series of processes, first in step S60, the management side control section 101 determines whether the management side control section 101 has obtained information that the automatic driving system can be updated. The information indicating the update as being available includes additional information of the peripheral monitoring sensor 17, and updated information of software which is for executing automatic driving. The information indicating the update as being available is inputted to the management server 100 from a server superior to the management server 100 via a communication network.

If an affirmative determination is made in step S60, the control proceeds to step S62 to calculate the charge incurred in updating the automatic driving system, and the difference of the unit-time charge between before and after the update of the system. For example, if the software for performing automatic driving is updated, the unit-time charge after the update is calculated to be lower than the unit-time charge of before update.

In subsequent step S64, update charge information is outputted to the management side communication section 102, the update charge information including information on the charge incurred in updating the automatic driving system, and information on the difference of the unit-time charge before and after the update of the system. Therefore, the update charge information is inputted to the vehicle side control unit 20 via the vehicle side communication unit 21.

FIG. 9 illustrates a procedure of a process performed by the vehicle side control unit 20. This process is, for example, repeatedly executed at predetermined processing intervals.

In a series of processes, first in step S70, the vehicle side communication unit 20 determines whether the update charge information has been received by the vehicle side communication unit 21. If an affirmative determination is made in step S70, the control proceeds to step S72 to notify the user of the charge required to update the automatic driving system, and the difference of the unit-time charge for the charged automatic driving before and after the update of the system, by using the navigation unit 19.

According to the present embodiment described above in detail, the following effects can be obtained.

The usage time period Tbill for the charged automatic driving performed by the user is calculated. Then, based on the calculated usage time period Tbill, the usage charge for the charged automatic driving is calculated. Thus, the business model can be accomplished in which the user is charged according to the usage time period Tbill of the automatic driving.

For example, during the charged automatic driving, the user may intervene in the driving operation to avoid a collision with a preceding vehicle. The time period in which the user intervenes in the driving operation does not correspond to a time period of driving operation mainly performed by the automatic diving system. Therefore, it is appropriate to exclude the time period of driving operation from the charged automatic driving. In the present embodiment, the time period in which the user performs the override operation during the charged automatic driving is excluded from the usage time period Tbill of the charged automatic driving. Therefore, even in the case where the user intervenes in the driving operation temporarily, the substantial usage time period of the charged automatic driving can be calculated.

Even during the charged automatic driving, it is appropriate to exclude the time period for responding to the emergency such as carrying a person who has been injured, from the usage time period of the charged automatic driving. Therefore, in the present embodiment, the time period required to respond to the emergency during the charged automatic driving is excluded from the usage time period Tbill of the charged automatic driving. Accordingly, the substantial usage time period of the charged automatic driving can be calculated.

A determination of a charge is required which is reasonable for usage situations of the automatic driving to reduce the cost involved in introducing the vehicle. In the present embodiment, the unit-time charge of the charged automatic driving is determined according to the associated information including the information indicating daytime or nighttime. Accordingly, the user can be charged with a charge reasonable for the usage scenes of the automatic driving.

If the automatic driving system can be updated, it is desirable to inform the user accordingly, from the perspective of enhancing the safety of the vehicle 10. In this regard, in the present embodiment, if the automatic driving system can be updated, the user is informed of the charge required to update the system, and the difference in unit-time charge for the charged automatic driving before and after the system update. Accordingly, the user can be prompted to update the automatic driving system. In particular, the user is notified of the difference of the charges per unit time. Therefore, the user can then be notified financial benefits that can be obtained by update such as one that the running cost of using the automatic driving is reduced. Therefore, the effect for prompting the user to update the automatic driving system can be enhanced.

Under the condition that the user is determined not to be in the waking state, a process is performed to invalidate the override operation of the user during the charged automatic driving. Accordingly, the charged automatic driving can be safely performed.

On condition that the determination is made that the user is not in the waking state, the process is preformed to facilitate the user's awakening. Accordingly, an accident of the vehicle 10 that may happen due to the user's low waking level can be prevented.

If it is determined that the danger avoidance operation is being performed, conditions during the danger avoidance operation are recorded to the vehicle side recording unit 22. Therefore, for example, information recorded to the vehicle side recording unit 22 can be used as an evidence to clarify where the responsibility for an accident lies.

### Second Embodiment

With reference to the drawings, a second embodiment will be described, focusing on the differences between the second embodiment and the first embodiment. In the present embodiment, the vehicle side control unit 20 calculates the usage charge of the charged automatic driving, in place of the management side control section 101.

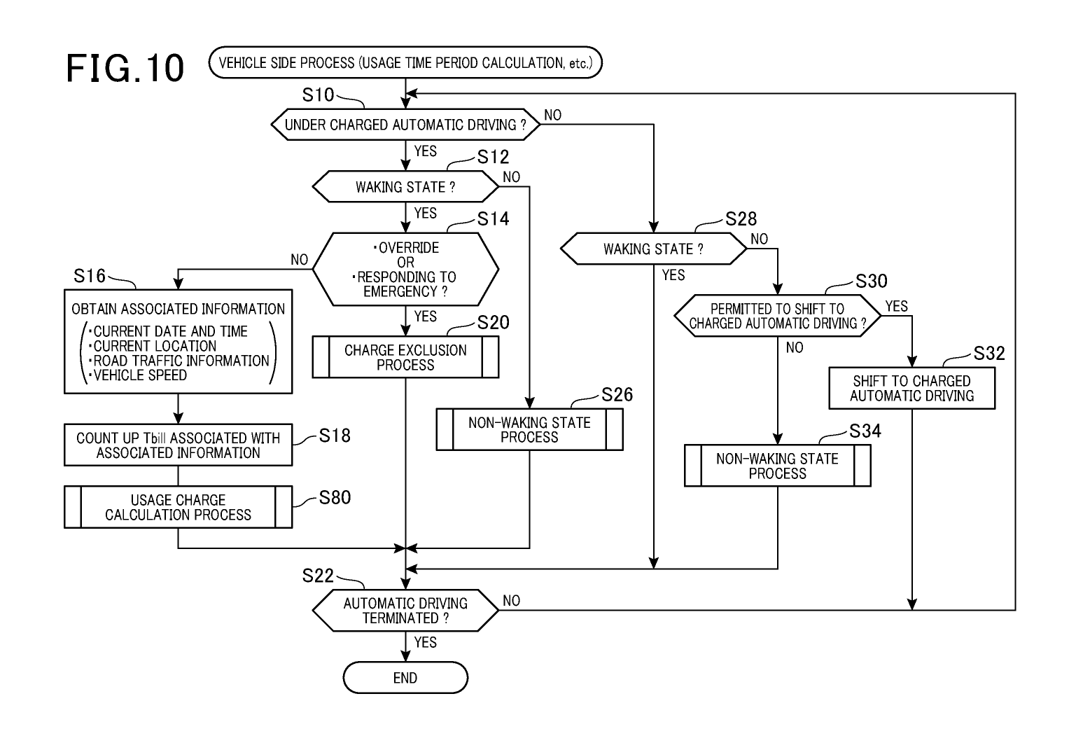

FIG. 10 shows a procedure of a process performed by the vehicle side control unit 20. In FIG. 10, the same processes as those illustrated in FIG. 2 are denoted by the same reference signs for convenience.

In a series of processes, when the process of step S18 is completed, the control proceeds to step S80 to perform a usage charge calculation process.

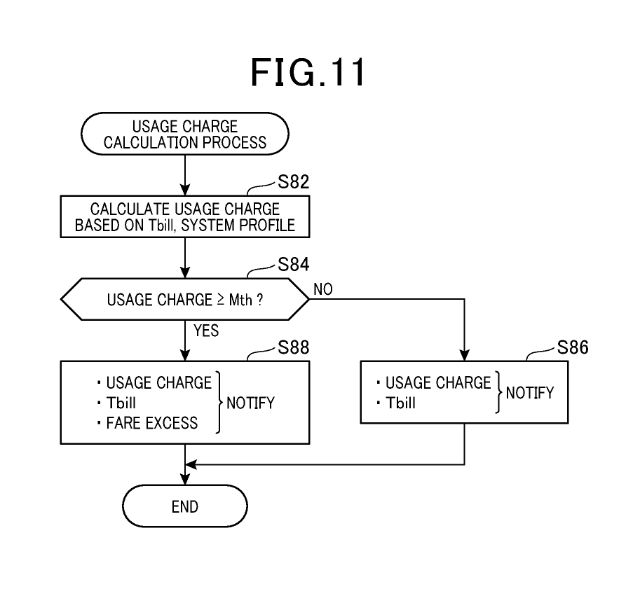

FIG. 11 illustrates the procedure of the usage charge calculation process.

In step S82, the usage charge of the charged automatic driving is calculated based on the usage time period Tbill calculated in step S18, and the unit-time charge of the charged automatic driving. As described in the first embodiment, the unit-time charge is determined according to the profile information of the automatic driving system, and the associated information.

Subsequently, in step S84, it is determined whether the usage charge calculated in step S82 is not less than the upper limit Mth.

If a negative determination is made in step S84, the control proceeds to step S86 to notify the user of the usage charge calculated in step S82, and the usage time period Tbill calculated in step S18, through the navigation unit 19.

In contrast, if an affirmative determination is made in step S84, the control proceeds to step S88 to notify the user of the excess information indicating the usage charge exceeding the upper limit, in addition to the usage charge and the usage time period Tbill, through the navigation unit 19.

In FIG. 10, an affirmative determination is made in step S22, a series of processes is temporarily terminated.

By a process similar to the process shown in FIG. 8 being performed, the vehicle side control unit 20 can notify the user of the charge required for the update of the automatic driving system, and the difference in unit-time charge before and after the update of the system.

The above-described present embodiment also can provide effects similar to those of the first embodiment.

### Third Embodiment

With reference to the drawings, a third embodiment will be described, mainly focusing on the differences between the third embodiment and the first embodiment. In the present embodiment, the management side control section 101 calculates the usage time period Tbill, in place of the vehicle side control unit 20.

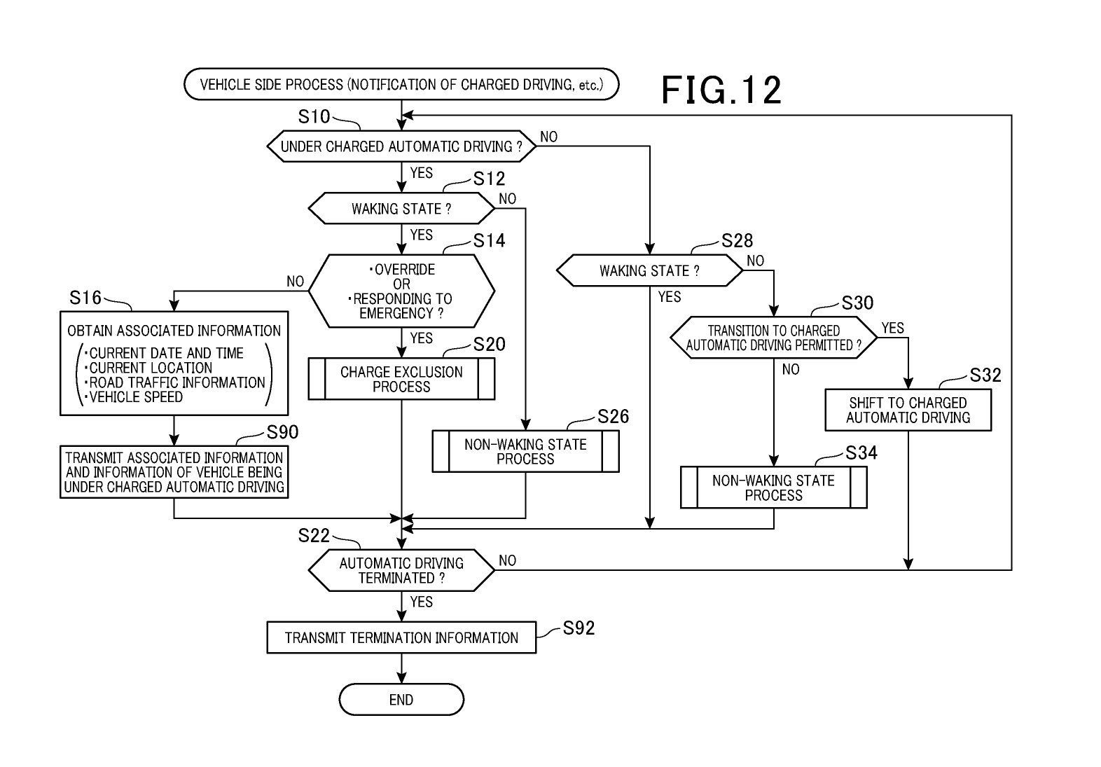

FIG. 12 shows a process performed by the vehicle side control unit 20. This process is executed as a trigger, for example, being determined as having started the automatic driving. In FIG. 12, the same processes as those illustrated in FIG. 2 are denoted by the same reference signs for convenience.

In a series of processes, when the process of step S16 is completed, the control proceeds to step S90. In step S90, the vehicle side control unit 20 outputs the associated information obtained in step

S16, and information on the charged automatic driving as being performed, to the vehicle side communication unit 21. The control then proceeds to step S22.

If an affirmative determination is made in step S22, the control proceeds to step S92 to output information indicating the automatic driving as having been terminated, to the vehicle side communication unit 21.

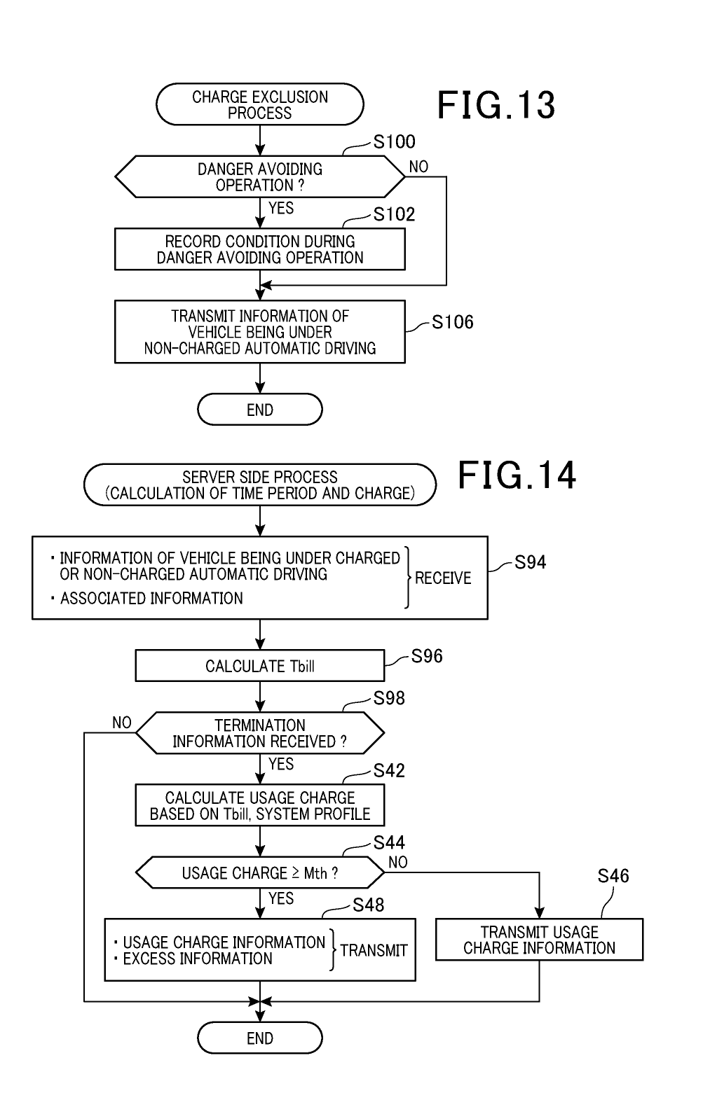

As shown in FIG. 13, in step S106 of the charge-exclusion process according to the present embodiment, the information indicating the non-charged automatic driving as being performed is outputted to the vehicle side communication unit 21, in place of the process in step S104 shown in FIG. 3.

Next, FIG. 14 illustrates a procedure of a process performed by the management side control section 101. This process is, for example, repeatedly executed at predetermined processing intervals.

In a series of processes, in step S94, the management side control section 101 receives information indicating charged automatic driving or non-charged automatic driving as being executed, and the associated information, from the management side communication section 102.

Subsequently, in step S96, based on the information indicating the charged automatic driving or the charged automatic driving being executed, the usage time period Tbill of the charged automatic driving is calculated. Specifically, if the information indicating the charged automatic driving as being executed is received in step S94, the management side control section 101 counts up the usage time period Tbill. If the information is received which indicates the non-charged automatic driving being performed, the management side control section 101 does not count up the usage time period Tbill. Thus, a usage time period Tbill is calculated. In step S96, similarly to step S18 in FIG. 2 in the first embodiment, the management side control section 101 associates the calculated usage time period Tbill with the associated information received in step S94.

Subsequently, in step S98, the management side control section 101 determines whether the information indicating the automatic driving as having been terminated has been received by the management side communication section 102. If an affirmative determination is made in step S98, the control proceeds to step S42 to calculate the usage charge for the charged automatic driving.

The above-described present embodiment also can provide effects similar to those of the first embodiment.

### Other Embodiments

The above embodiments may be modified and implemented as below.

In the first embodiment, the usage time period of the charged automatic driving in one trip is counted. One trip corresponds to the time period from the start of the automatic driving until the termination thereof. Then, the calculated usage time period information is transmitted to the management server 100. However, the configuration is not limited to this. For example, the usage time period information may be transmitted to the management server 100 at processing intervals.

Part of the associated information shown in FIG. 6 may be used to determine a unit-time charge.

The usage time period information included in the associated information may include at least one of day-of-the-week information and weekday-or-holiday information. If weekday-or-holiday information is included, information indicating whether the holiday is a regular holiday or a holiday in a particular period, such as consecutive holidays, may further be included. The unit-time charge of the charged automatic driving may be higher on the holiday than that on the weekday. The unit-time charge of the charged automatic driving for the holiday in a particular period may be determined to be higher than the unit-time charge for the regular holiday.

In the first embodiment, the user's abnormal behavior by which the override operation is invalidated is dozing. However, a direction of the user's line of sight being other than toward the front, and great change of the user's posture may be included.

In the first embodiment, the vehicle side control unit 20 mounted to the vehicle and dedicated thereto performs processes shown in FIGS. 2 to 4, 7, and 9, but the configuration is not limited to this. These processes may, for example, be performed by a mobile terminal carried by the user. In this case, the usage charge, and the like may be notified to the user by a display function of the mobile terminal such as a display, or a voice generating function of the mobile terminal.

If the information indicating that the automatic driving system can be updated is obtained, it is not necessary to notify the user of the charge required for updating the automatic driving system. This is because, for example, the charge required for updating the system may be borne by the vehicle manufacturer as a complimentary service.

In place of the usage time period, a usage distance may be used, or both the usage time period and the usage distance may be used to calculate the usage charge of the charged automatic driving. If the usage distance is used to calculate the usage charge, the usage distance increases only when the vehicle 10 is traveling, but does not increase while the vehicle 10 is stopped, even if time elapses.

A unit-distance charge for the charged automatic driving used to calculate the usage charge may be determined to be higher, if the usage time zone of the charged automatic driving is nighttime, than in the daytime, similarly to the unit-time charge shown in FIG. 6. The unit-distance charge of the charged automatic driving may be determined to be lower if the profile of the automatic driving system has higher performance. If the information indicating that the automatic driving system can be updated is obtained, the management server may generate the information on the difference in unit-distance charge before and after the update of the automatic driving system.

The vehicle may not be limited to one provided only with an engine as the traveling power source, but may be one provided only with a motor, or one provided with both the engine and the motor.

The present disclosure has been described based on embodiments, however the present disclosure should not be construed as being limited to these embodiments and configurations. The present disclosure should encompass various modifications or variations within the range of equivalents. In addition, various combinations or modes, and even other combinations or modes including one or more elements or one or less elements fall within the scope and the spirit of the present disclosure.

1. A vehicle apparatus which is applied to a vehicle and enables automatic driving to a destination without requiring a driving operation by a user, the vehicle apparatus comprising:
an information obtaining section which obtains information indicating that the automatic driving is used by the user as charged automatic driving; and
a usage parameter calculation section which calculates a usage parameter which is at least one of a usage time period and a usage distance of the charged automatic driving by the user, based on the information obtained by the information obtaining section, wherein
the information obtaining section obtains information indicating that the user is intervening in the driving operation of the vehicle during the charged automatic driving, and
the usage parameter calculating section calculates the usage parameter by excluding an intervention time period in which the user intervenes in the driving operation during the charged automatic driving, based on the information indicating that the user is intervening in the driving operation.

2. (canceled)

3. The vehicle apparatus according to claim 1, wherein
the information obtaining section obtains information indicating that the user is responding to an emergency during the charged automatic operation, and
the usage parameter calculation section calculates the usage parameter by excluding a response time period in which the user responds to the emergency during the charged automatic driving, based on the information indicating that the user is responding to the emergency.

4. The vehicle apparatus according to claim 1, comprising:
an information transmitting section that transmits information on the usage parameter which is calculated by the usage parameter calculation section, to a management server which generates usage charge information of the charged automatic driving, based on the usage parameter; and
a notification section which receives the usage charge information generated by the management server, and notifies the user of the received usage charge information.

5. The vehicle apparatus according to claim 4, wherein
the information transmitting section transmits associated information including at least one of usage time period information during the charged automatic driving and vehicle traveling information during the charged automatic driving, in association with the information on the usage parameter, to the management server, and
the management server generates the usage charge information, based on unit-time charge information or unit-distance charge information of the charged automatic driving according to the associated information, and the information on the usage parameter transmitted from the information transmitting section.

6. The vehicle apparatus according to claim 4, wherein
the management server generates the usage charge information based on the unit-time charge information or the unit-distance charge information of the charged automatic driving according to a profile of an automatic driving system provided to the vehicle and the information on the usage parameter transmitted from the information transmitting section;
the management server generates update charge information including a difference in a unit-time charge or a difference in a unit-distance charge before and after update of the automatic driving system, if the management server obtains information indicating that the automatic driving system is able to be updated, and
the notification section receives the update charge information generated by the management server, and notifies the user of the received update charge information.

7. A vehicle system comprising:
the vehicle apparatus according to claim 4; and
the management server according to claim 4.

8. (canceled)

9. (canceled)

10. (canceled)

11. The vehicle apparatus according to claim 1, comprising:
an abnormality determination section that determines an abnormal behavior of the user sitting in a driver's seat of the vehicle; and
an invalidation control section that controls the vehicle so as to invalidate a driving operation performed by the user during the charged automatic driving, if the abnormality determination section determines the behavior of the user being abnormal, and even when the driving operation is performed.

12. The vehicle apparatus according to claim 1, comprising:
an abnormality determination section which determines abnormality of the user sitting in the driver's seat of the vehicle; and
an operation shifting section that forcibly shifts a driving mode to the charged automatic driving based on a determination of abnormality by the abnormality determination section under a condition that the charged automatic driving is not being performed, wherein
if a forcible shift to the charged automatic driving has been performed by the operation shifting section, the usage parameter calculation section calculates the usage parameter of the charged automatic driving after the shift.

13. The vehicle apparatus according to claim 1, wherein:
the vehicle is provided with a recording unit in which a driving situation of the vehicle is recorded,
the apparatus comprises:
a danger determination section that determines whether a danger avoidance operation for the vehicle has been performed by the user during the charged automatic driving; and
a record processing section that records the driving situation of the vehicle to the recording unit, if the danger determination section determines that the danger avoidance operation has been performed.

14. A vehicle system provided with a vehicle apparatus which is applied to a vehicle and enables automatic driving to a destination without requiring a driving operation by a user, and a management server, wherein
the vehicle apparatus transmits information indicating that the automatic driving is used by the user as charged automatic driving, to the management server,
the management server includes a usage parameter calculation section that receives the information indicating that the charged automatic driving is used, and based on the received information, the usage parameter calculation section calculating a usage parameter which is at least one of a usage time period and a usage distance of the charged automatic driving,
the vehicle apparatus transmits information indicating that the user is intervening in the driving operation of the vehicle, to the management server during the charged automatic driving, and
the usage parameter calculation section calculates the usage parameter by excluding an intervention time period in which the user intervenes in the driving operation during the charged automatic driving, based on the received information indicating that the user is intervening in the driving operation.

15. (canceled)

16. The vehicle system according to claim 14, wherein
the vehicle apparatus transmits information indicating that the user is responding to an emergency during the charged automatic driving, and
the usage parameter calculation section calculates the usage parameter by excluding a response time period in which the user is responding to the emergency during the charged automatic driving, based on the received information indicating that the user is responding to the emergency.

17. The vehicle system according to claim 14, wherein
the management server includes a charge information generation section that generates usage charge information of the charged automatic driving, based on the usage parameter calculated by the usage parameter calculation section, and
the vehicle apparatus includes a notification section that receives the usage charge information generated by the usage charge information generation section and notifies the user of the received usage charge information.

18. The vehicle system according to claim 14, wherein
the vehicle apparatus transmits associated information including at least one of usage time period information during the charged automatic driving and vehicle traveling information during the charged automatic driving, in association with information indicating that the charged automatic driving is being used, to the management server, and
the management server includes a charge information generation section that generates usage charge information of the charged automatic driving, based on unit-time charge information or unit-distance charge information of the charged automatic driving according to the associated information, and the usage parameter calculated by the usage parameter calculation section.

19. The vehicle system according to claim 18, wherein
the management server includes the charge information generation section that generates the usage charge information of the charged automatic driving, based on the unit-time charge information or the unit-distance charge information of the charged automatic driving according to a profile of an automatic driving system provided to the vehicle, and the usage parameter calculated by the usage parameter calculation section,
the charge information generation section generates update charge information including information on a difference in unit-time charge or a difference in unit-distance charge before and after update of the automatic driving system, if the charge information generation section obtains information indicating that the automatic driving system is able to be updated, and
the vehicle apparatus includes a notification section that receives the update charge information generated by the charge information generation section and notifies the user of the received update charge information.

20. The vehicle apparatus according to claim 14, wherein
the vehicle apparatus includes:
an abnormality determination section that determines an abnormal behavior of the user sitting in a driver's seat of the vehicle; and
an invalidation control section that controls the vehicle so as to invalidate a driving operation performed by the user during the charged automatic driving, if the abnormality determination section determines the behavior of the user being abnormal, and even when the driving operation is performed.

21. The vehicle apparatus according to claim 14, wherein
the vehicle apparatus includes:
an abnormality determination section that determines the abnormal behavior of the user sitting in a driver's seat of the vehicle; and
an operation shifting section that forcibly shifts a driving mode to the charged automatic driving, based on a determination of abnormality performed by the abnormality determination section, under a condition that charged automatic driving is not being performed, wherein
if a forcible shift to the charged automatic driving has been performed by the operation shifting section, the usage parameter calculation section calculates the usage parameter of the charged automatic driving after the shift.

22. The vehicle system according to claim 14, wherein
the vehicle is provided with a recording unit in which a driving situation of the vehicle is recorded,
the apparatus comprises:
a danger determination section that determines whether a danger avoidance operation for the vehicle has been performed by the user during the charged automatic driving; and
a record processing section that records the driving situation of the vehicle to the recording unit, if the danger determination section determines that the danger avoidance operation has been performed.

23. A vehicle apparatus which is applied to a vehicle and enables automatic driving to a destination without requiring a driving operation by a user, the vehicle apparatus comprising:
an information obtaining section which obtains information indicating that the automatic driving is used by the user as charged automatic driving; and
a usage parameter calculation section which calculates a usage parameter which is at least one of a usage time period and a usage distance of the charged automatic driving by the user, based on the information obtained by the information obtaining section, wherein
the information obtaining section obtains information indicating that the user is responding to an emergency during the charged automatic operation, and
the usage parameter calculation part calculates the usage parameter by excluding a response time period in which the user responds to the emergency during the charged automatic driving, based on the information indicating that the user is responding to the emergency.

24. A vehicle apparatus which is applied to a vehicle and enables automatic driving to a destination without requiring a driving operation by a user, the vehicle apparatus comprising:
an information obtaining section which obtains information indicating that the automatic driving is used by the user as charged automatic driving;
a usage parameter calculation section which calculates a usage parameter which is at least one of a usage time period and a usage distance of the charged automatic driving by the user, based on the information obtained by the information obtaining section;
an abnormality determination section which determines abnormality of the user sitting in the driver's seat of the vehicle; and
an operation shifting section that forcibly shifts a driving mode to the charged automatic driving based on a determination of abnormality by the abnormality determination section under a condition that the charged automatic driving is not being performed, wherein
if a forcible shift to the charged automatic driving has been performed by the operation shifting section, the usage parameter calculation section calculates the usage parameter of the charged automatic driving after the shift.

25. A vehicle system provided with a vehicle apparatus which is applied to a vehicle and enables automatic driving to a destination without requiring a driving operation by a user, and a management server, wherein
the vehicle apparatus transmits information indicating that the automatic driving is used by the user as charged automatic driving, to the management server, and
the management server includes a usage parameter calculation section that receives the information indicating that the charged automatic driving is used, and based on the received information, the usage parameter calculation section calculating a usage parameter which is at least one of a usage time period and a usage distance of the charged automatic driving, wherein
the vehicle apparatus transmits information indicating that the user is responding to an emergency during the charged automatic driving, and
the usage parameter calculation section calculates the usage parameter by excluding a response time period in which the user is responding to the emergency during the charged automatic driving, based on the received information indicating that the user is responding to the emergency.

26. A vehicle system provided with a vehicle apparatus which is applied to a vehicle and enables automatic driving to a destination without requiring a driving operation by a user, and a management server, wherein
the vehicle apparatus transmits information indicating that the automatic driving is used by the user as charged automatic driving, to the management server,
the management server includes a usage parameter calculation section that receives the information indicating that the charged automatic driving is used, and based on the received information, the usage parameter calculation section calculating a usage parameter which is at least one of a usage time period and a usage distance of the charged automatic driving, and
the vehicle apparatus includes:
an abnormality determination section that determines the abnormal behavior of the user sitting in a driver's seat of the vehicle; and
an operation shifting section that forcibly shifts a driving mode to the charged automatic driving, based on a determination of abnormality performed by the abnormality determination section, under a condition that charged automatic driving is not being performed, wherein
if a forcible shift to the charged automatic driving has been performed by the operation shifting section, the usage parameter calculation section calculates the usage parameter of the charged automatic driving after the shift.
